(19) United States
(12) Patent Application Publication
(10) Pub. No.: US 2011/0150395 A1
(43) Pub. Date: Jun. 23, 2011

(54) Method and an Apparatus For Batch Cleaving of Fiber Optics Connectors Before Polishing

(76) Inventors: Serge Steinblatt, Ra'anana (IL); Ori Sarfaty, Ramat Hasharon (IL); Rami Gazit, Ganei Tikva (IL); Ofer Bendet, Tel-Aviv (IL); Benjamin Karov, Ramat Hasharon (IL); Yaron Gold, Zichron Yaakov (IL); Daniel Hachnochi, Tel Aviv (IL)

(21) Appl. No.: 11/631,016

(22) PCT Filed: Sep. 11, 2005
(86) PCT No.: PCT/IL05/00960

§ 371 Date: Mar. 10, 2011

(30) Foreign Application Priority Data
Sep. 14, 2004 (IL) 164068

(51) Int. Cl. G02B 6/38

(52) U.S. Cl. 385/59

(57) ABSTRACT

Disclosed is a method of severing a fiber length projecting out of the end face of a plurality of ferrules. The ferrules are mounted in a polishing fixture. Image processing establishes the fiber cleaving plane. Relative movement between the laser beam and the ferrule severs the fiber protruding out of the ferrule end-face. Excess epoxy that may be present on the ferrule end-face is removed concurrently with the fiber severing process. The method includes cleaning and inspection of ferrules.

### TECHNICAL FIELD

The present invention relates to the field of optical fiber cable manufacturing and in particular to optical fiber cable polishing and optical inspection.

### BACKGROUND

With the growth of optical communication networks there is a growing need for altering a network configuration, connecting to it new nodes and devices, disconnecting old devices and maintaining the network. These connections are easy and convenient to make with the help of optical fiber cables or optical fiber patch cords, terminated by an optical connector. An optical connector is a demountable device for attaching an optical fiber cable or optical fiber patch cord to another optical fiber cable or patch cord, or to an active or passive device.

In order to reduce optical signal power coupling losses, the end-face of an optical connector typically comprising an optical fiber inserted into a ferrule is polished. For polishing, a batch (or a plurality) of optical connectors is mounted in a polishing fixture typically holding from 1 to 60 simultaneously polished connectors. Polishing usually takes place after the connectors are prepared for polishing. Preparation for polishing may include fiber severing and removing excess adhesive, such as epoxy removal. Known prior art includes U.S. Pat. No. 5,421,928 to Knecht.

It would be desirable to make preparation of ferrules of optical cables for polishing on the polishing fixture itself.

### BRIEF LIST OF EXTRACTINGS

The disclosure is provided by way of non-limiting examples only, with reference to the accompanying drawings, wherein:

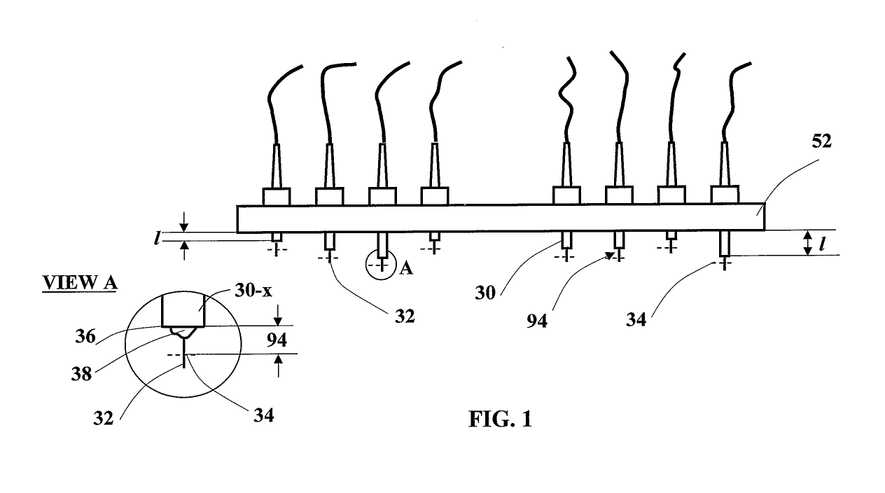

FIG. 1 is a schematic illustration showing the ferrules protruding at different lengths out of a polishing fixture.

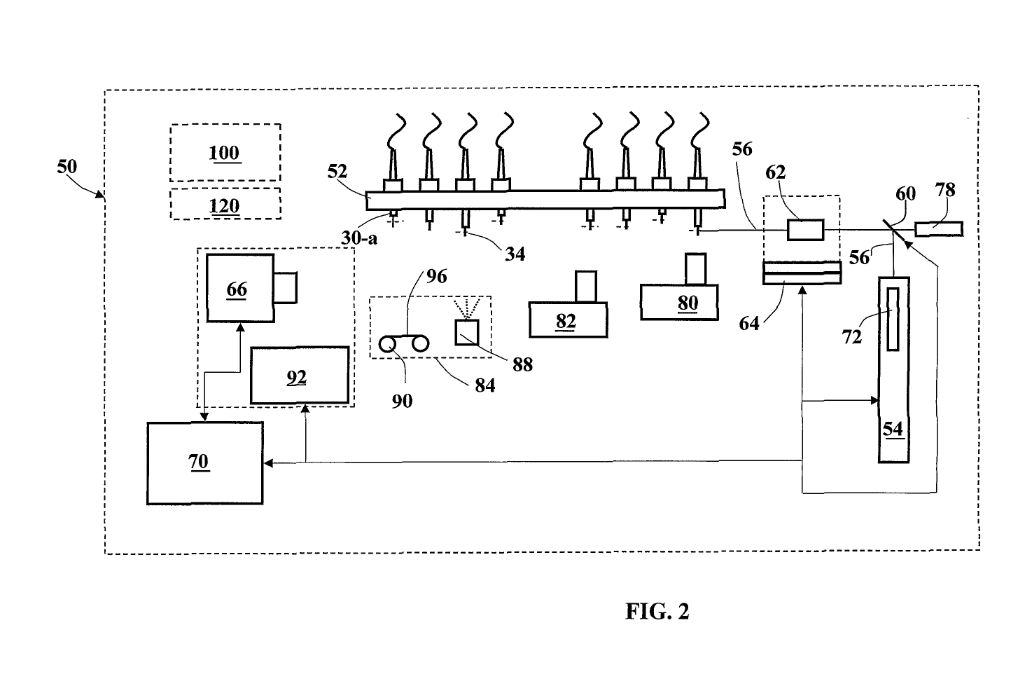

FIG. 2 is a schematic illustration of the apparatus for severing a fiber length projecting out of the end face of a plurality of ferrules.

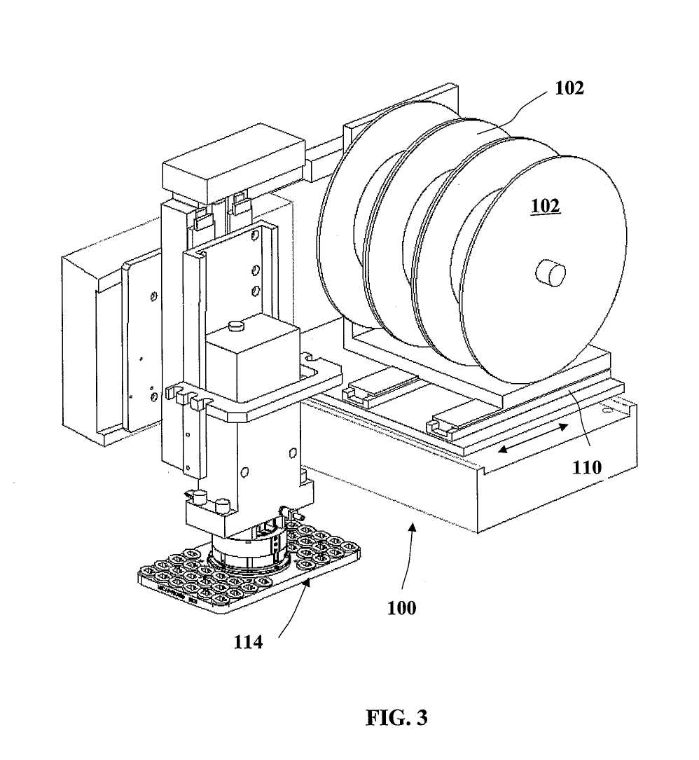

FIG. 3 is a schematic illustration of a handling support for long optical cables.

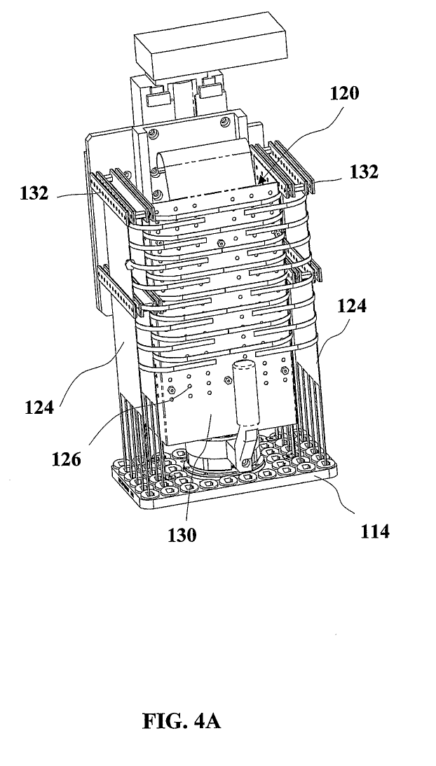

FIGS. 4A and 4B are schematic illustrations of a flexible optical circuit support rack.

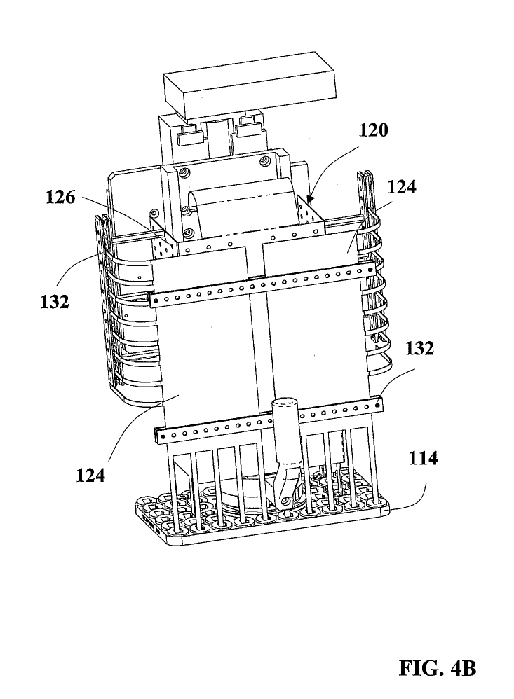

FIG. 5 is a schematic illustration of a contour line generated by image processing of a ferrule image.

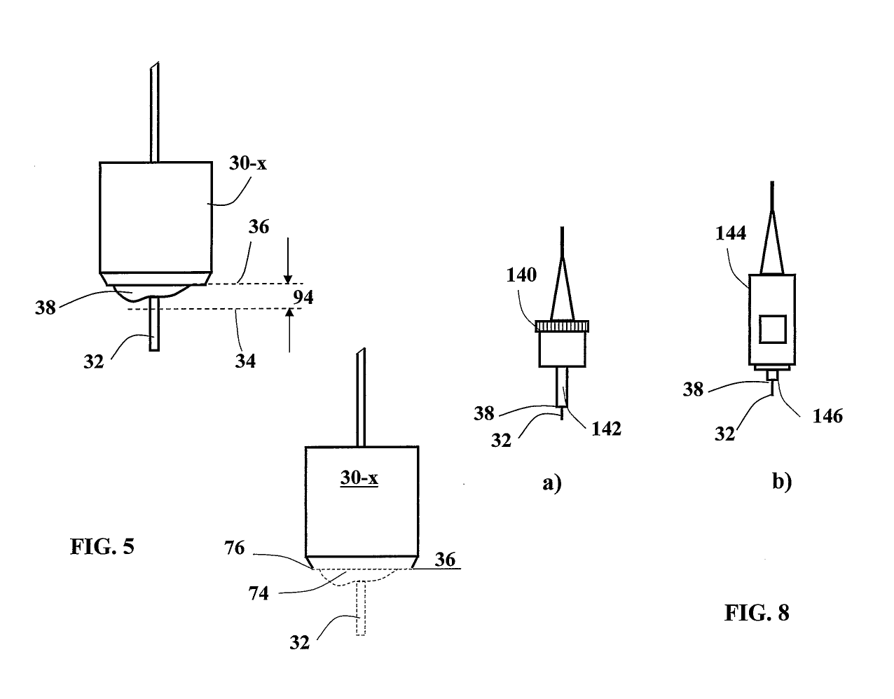

FIG. 6 is a schematic illustration of an exemplary embodiment of a polishing fixture.

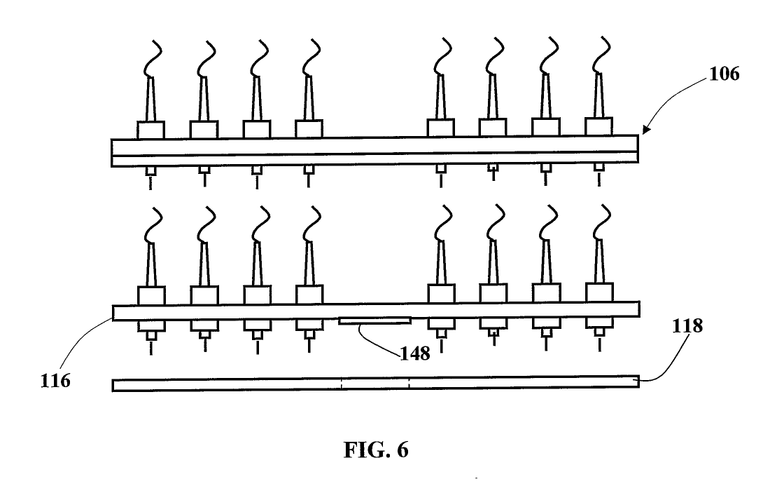

FIG. 7 is a schematic illustration of the apparatus for severing a fiber length projecting out of the end face of a plurality of ferrules.

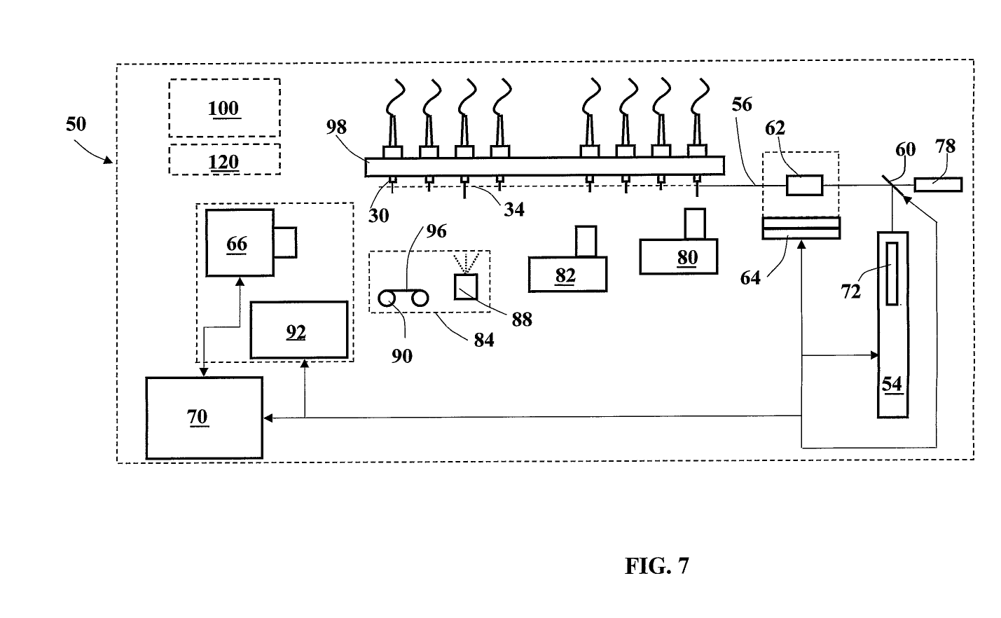

FIG. 8 is a schematic illustration of different types of optical connectors.

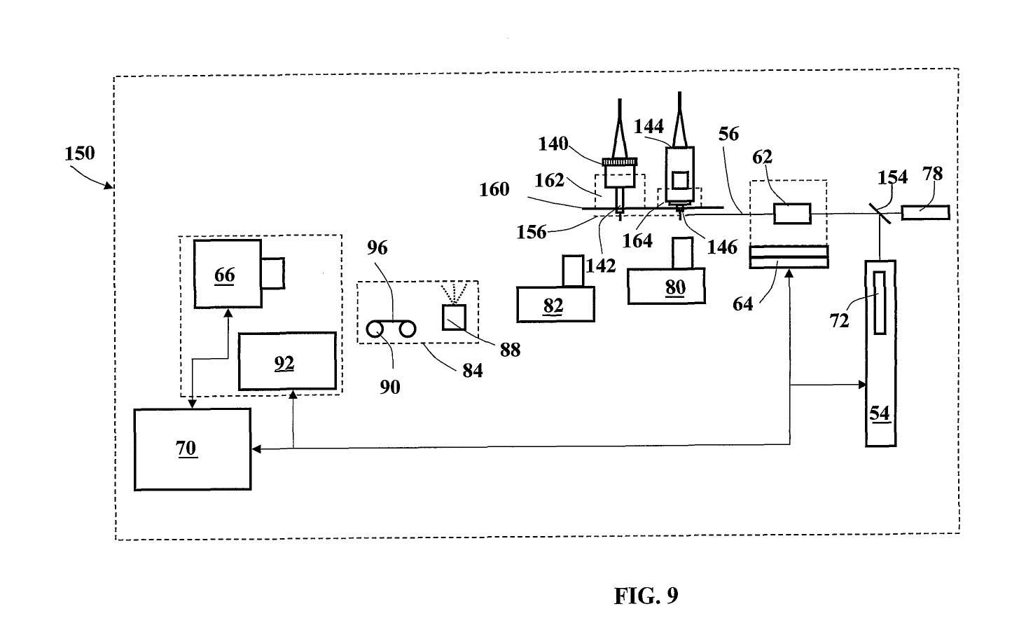

FIG. 9 is a schematic illustration of an improved epoxy removal and fiber severing apparatus.

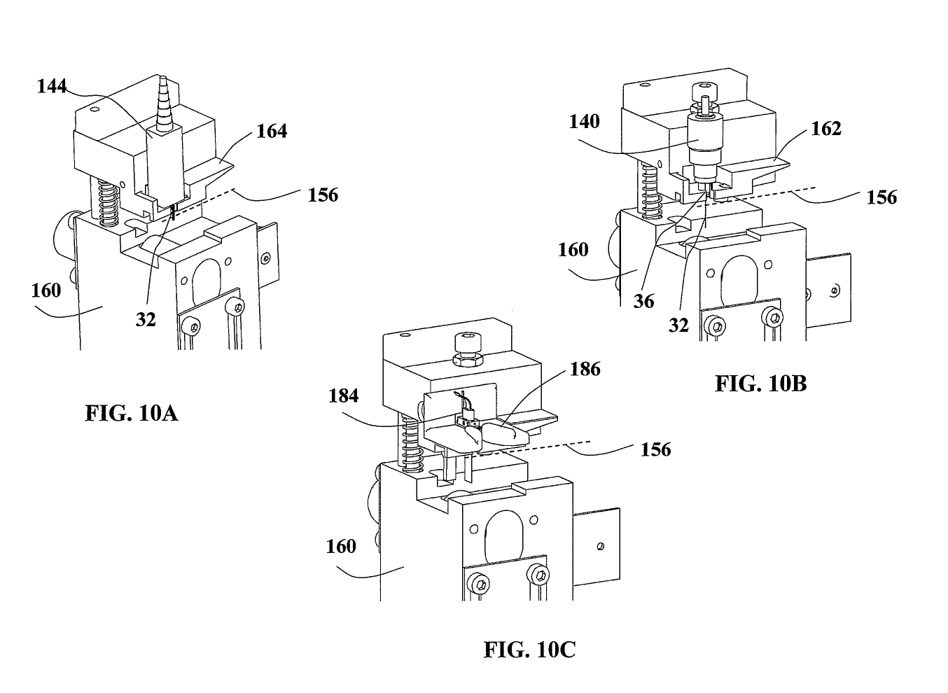

FIG. 10 is a schematic illustration of optical connector adaptors useful in the epoxy removal and fiber severing processes.

### DETAILED DESCRIPTION

The principles and execution of a method, and the operation and properties of the associated hardware and software described thereby may be understood with reference to the drawings, wherein like reference numerals denote like elements through the several views and the accompanying description of non-limiting, exemplary embodiments.

The term “ferrule” as used in the text of the disclosure, device refers to an optical connector the polished end-face of which comprises a fiber inserted into a ferrule. The term “ferrule” includes fiber stubs, simplex fiber connectors, duplex fiber connectors and multiple fiber type connectors.

In the process of optical cable manufacturing, the optical fiber is inserted into a connector ferrule and secured to it by adhesive. There is no control over the length of the fiber projecting out of the ferrule. In many cases, the epoxy spills out of the ferrule. For polishing, a batch of ferrules 30 as shown in FIG. 1, may be mounted in a polishing fixture 52. When mounted in polishing fixture 52, ferrules 30 may protrude to different length l. Fibers 32 projecting out of ferrule end-face 36 may have different lengths. Since polishing may require a controlled and sometimes uniform length of fiber 32 projecting out of ferrule end-face 36, the severing has to be done for each fiber in a different plane marked by phantom line 34.

Reference now is made to FIG. 2, which is a schematic illustration of the apparatus for severing a fiber length projecting out of the end face of a plurality of ferrules. Apparatus 50 may include a polishing fixture 52, a laser 54, emitting laser beam 56, laser beam aiming and steering mechanism 60, laser beam focusing optics 62, motion mechanism 64, video camera 66 and a control computer 70. Control computer 70 may govern the operation of apparatus 50. Apparatus 50 may sever a fiber by ablating a section of it by laser beam 56. Accordingly, laser 54 may emit a beam with a wavelength well absorbed by the fiber material. A CO₂ laser may be such a laser, although lasers emitting laser beams with other wavelengths, less absorbed by the fiber material, can be used. In case where laser 54 emits a non visible laser beam, it may optionally have a built-in pointing laser 72 that provides a laser beam of a visible wavelength. The beam of pointing laser 72 may be aligned coaxially with the CO₂ laser beam. Alternatively, pointing beam laser 72 may be an external laser or a Light Emitting Diode (LED) 78 emitting a red, green, blue or any other visible wavelength beam.

Further included in the apparatus may be a device for collecting and disposing the removed fiber debris 80, such as a suction mechanism, device for extracting fumes and odor 82 generated by the epoxy and fiber removal process, and ferrule end-face cleaning device 84. Ferrule end-face cleaning device 84 may include a sprayer 88 for spraying a detergent or other cleaning type solution and wiping material holder 90 providing wiping material 96.

In the process of preparation for polishing, the handling of relatively short fiber cables (1-3 meters) does not present any significant problems. Handling of long fiber cables (tens and hundreds of meters) may be problematic. As shown in FIG. 3 apparatus 50 may further include an optical cable support 100 including at least one reel 102 for receiving lengths of optical cables associated with the ferrule being processed. Cable support 100 may further include a displacement mechanism 110 configured to allow displacement of one or more reels 102 in at least one direction. A particular polishing fixture 114 shown in FIG. 3 is a two dimensional matrix type fixture.

Flexible optical circuits may have their input output connections terminated by ferrules. Apparatus 50 may further include a flexible optical circuit support rack 120 (FIGS. 4A and 4B) associated with polishing fixture 114 for supporting a flexible optical circuit 124 associated with the ferrules being processed. Flexible optical circuit support rack 120 may include a clamping plate 130 extending vertically above polishing fixture 114. The clamping plate may have a two dimensional array of bolt holes 126. Bars 132 may clamp flexible optical circuit 124 to clamping plate 130 of support rack 120.

For severing a fiber length 94, projecting out of the end face 36 of a plurality of ferrules 30 (FIGS. 1 and 2), ferrules may be mounted in fixture 32. Camera 66 (FIG. 2) may acquire silhouette images of plurality of ferrules 30. The term “camera” as used in the text of the disclosure refers to a video camera with associated image processing software, although the software may operate on the control computer or on the processor associated with the camera. Relative motion between camera 66 and fixture 52 may facilitate image acquisition. The position of each of the plurality of ferrules 30 in polishing fixture 52 and fiber-severing plane 34 may be determined by processing the image acquired. Fiber-severing plane 34 is the plane in which fiber severing or the actual cleave is made. The position of plane 34 determines the length of the fiber to be left. A laser beam aiming and steering mechanism 60, which may be a scanning mirror or other device capable of steering and aiming a laser beam, directs laser beam 56 such that the axis of symmetry of beam 56 is in fiber-severing plane 34. Laser beam imaging optics 62 may focus laser beam 56 on fiber 32 into a spot smaller than the fiber diameter. Motion mechanism 64 provides a relative movement between laser beam 56 and ferrule 30 such that laser beam 56 severs fiber 32 projecting out of ferrule end-face 36. Alternatively, fixture 52 may be moved versus a static laser beam. A combination of complimentary movements involving laser beam 56 and polishing fixture 52 may be used to sever the fiber.

In the course of image processing, one of the plurality of ferrules (connectors), for example ferrule 30-a (FIG. 2) mounted in the polishing fixture may be assumed to represent the zero point of the coordinate system in which plurality 30 of ferrules is positioned. Coordinates of all other ferrules mounted in a fixture having a linear array pattern or a two dimensional matrix pattern of ferrules may be determined relatively to that ferrule. The process of determination of the coordinate system in which plurality of ferrules 30 is positioned may take place for each new batch of ferrules. Alternatively, ferrule positions for similar fixtures may be stored in a memory and retrieved if a known geometry fixture is used.

Processing of the image captured may include fiber severing plane 34 determination (FIG. 5). In order to determine the spatial position of fiber-severing plane 34 for each of the plurality of ferrules, the position of ferrule end-face plane 36 may be determined. “Ferrule end-face plane” is defined as the plane that is tangent to the ferrule at the point where the fiber emerges from the ferrule. This plane may be obscured by excess epoxy 38, in which case the position of plane 36 may be estimated from a more definite visible feature, such as the ferrule shoulders 76. The estimation may be obtained by generating the outer contour 74 of ferrule 30-x. For example, this may be done by ferrule edge detection where the gradient value at each point in silhouette ferrule 30-x image may be computed. The outer contour of ferrule 30-x may include the contour of excess epoxy 38 and fiber length 32. Based on the outer contour generated, computer 70 may for example, extract the fiber centerline; find the average peak location of a convolution of the edge image with a horizontal kernel. Fitting a curve to ferrule shoulders—may include at least one iteration of mathematical fit followed by eliminating outliers. Location of fiber end-face 36 may be performed by for example, determining the point of intersection between the centerline and the fit curve. Fiber length 94 may be measured from ferule end-face 36.

Relative movement between laser beam 56 and the plurality of females 30 may perform fiber severing and epoxy removal. As the relative movement between laser beam 56 and ferrule 30 takes place, control computer 70 that may control operation of motion system 64 and laser 54 may activate laser 54 synchronously with the position of each of the plurality of ferrules 30 mounted in polishing fixture 52 and determined by appropriate image processing. Positions of each of the plurality of ferrules 30 may be kept in memory of computer 70, motion system 64, or retrieved from memory in the case where a fixture with known geometry is used. Positions of each of the plurality of ferrules 30 may be communicated to laser beam steering system 60. System 60 automatically steers laser beam 56 and directs laser beam orientation such as to sever fiber length in fiber severing plane 34. Laser beam 56 positioning may further include directing of laser beam 56 such that it severs fiber 32 at an angle of 90 degrees, although some small deviations from this angle may be accepted. Laser beam 56 may be focused to a spot having a diameter smaller than the diameter of fiber 32.

Laser beam steering mechanism 60 based on the results of image processing, may automatically perform laser beam 56 aiming such as to sever the fiber length in fiber severing plane 34 at an angle of 90 degrees. Some types of ferrules may protrude out of fixture 52 (FIGS. 1 and 2), which in one of the embodiments may be a solid body at a relatively small distance. It may be difficult, especially with fixtures having a two dimensional array of ferrules, at small protrusion values to direct laser beam 56 such as to sever the fiber length in fiber severing plane 34 at an angle of 90 degrees. FIG. 6 is a schematic illustration of another embodiment of polishing fixture 106. Polishing fixture 106 may be an assembly of two plates: upper plate 116 and lower plate 118. Upper plate 116 may include connector mounts where lower plate 118 provides the desired fixture stiffness. Lower plate 118 is removed for the fiber severing and epoxy removal processes and replaced for the polishing process.

Concurrently with severing fiber 32, laser beam 54 may remove excess epoxy 38 present on ferrule end-face 36 (FIG. 5). The heat generated in the process of fiber section ablation by laser beam 56 removes epoxy 38. Plane 34 may be close enough to the ferrule end-face 36 enabling sufficient heat conduction and excess epoxy 38 removal concurrent with the fiber severing. A ferrule end-face cleaning system 84 (FIG. 2) may clean end-face 36 and an inspection system 92 may inspect ferrules 30 having removed excess epoxy 38 and fiber 32 projecting out of the ferrule end-face 36. Inspection of fiber 32 and end-face 36 may include fiber length determination, cleanliness of ferrule end-face, form and shape of fiber tip and other criteria. Computer 70 may generate an inspection report containing the results of the inspection.

The process of severing fiber 32 generates certain debris in the form of pieces of severed fiber. Epoxy 38 and fiber 32 removal generates some odor and fumes. Automatic debris removal device 80, fumes and odor extracting device 82 may receive and remove debris and extract fumes and odor. Removal of excess epoxy and corresponding fume and odor extraction takes place concurrently to fiber severing.

U.S. patent application Ser. No. 10/851,119 to the same Assignee among others, discloses polishing fixture 98 and a method of loading such a fixture by a batch of ferrules such that the plurality of ferrules 30, as shown in FIG. 7, have equal protrusion. For severing a fiber length 94 projecting out of the end face 36 of a plurality of ferrules 30 camera 66 may acquire silhouette images of plurality of ferrules 30 only once. For fixtures with known geometry, it may be sufficient to acquire an image of only one ferrule. Fiber-severing plane 34 may be the same plane for a plurality of ferrules 30 that may have an equal protrusion.

Methods of severing a fiber length projecting out of the ferrule end face on a one-by-one basis are known. In practice, there is a frequent need to prepare for polishing optical cables terminated by different types of connectors. For example, FIG. 8a is a schematic illustration of a cable terminated by an ST/FC-type connector 140 having a relatively long ferrule 142 and FIG. 8b is a schematic illustration of another cable terminated by a SC-type connector 144 having a relatively short ferrule 146.

For severing different types of connectors, a prior art apparatus has to be readjusted. Apparatus 150 (FIG. 9) is an improvement over the known apparatus and method for severing a fiber length projecting out of the end face of a ferrule in that it allows severing different types of connectors without readjusting the apparatus. Laser beam steering mechanism 154 may direct the orientation of laser beam 56 such that its axis of symmetry resides in reference plane 156. Plane 156 determines the length of the fiber to be left. Once directed, the position and orientation of laser beam 56 may remain fixed. Laser beam 56 may be focused to a spot smaller than the fiber diameter.

Apparatus 150 may further include a mount 160 for mounting ferrules 142 or 146 in a way such that the distance between ferrule end face and reference plane 156 determines the length of the fiber to be left. Mount 160 may have a receptacle for receiving an exchangeable adaptor 162 or 164 matching the type of connector to be processed. Adaptors 162 or 164 enable placement of ferrule end-faces of the different types of connectors at the same reference plane 156. Motion system 64 provides relative movement between laser beam 56 and ferrule 140 or 142. Alternatively, the laser beam may provide a relative movement by scanning the fiber to be severed. Apparatus 150 may further include device 80 for collecting and disposing removed fiber debris and device 82 for extracting fumes and odor generated by the epoxy and fiber removal process. In addition, apparatus 150 may include ferrule end-face cleaning device 84, camera 66, inspection system 92, and control computer 70.

For severing a fiber length, connector 140 (ferrule 142) is mounted in an appropriate adaptor, such as adaptors 162 or 164 as shown in FIG. 10 for example. In a similar way, multi fiber connector (MT) 184 may be mounted in adaptor 186. Adaptors 162, 164 and 186 are inserted in receptacle 160 such that the distance between ferrule end-face 36 and reference plane 156 determines the length of the fiber to be left. One or more mechanical stops may ensure repetitive adaptor and connector positions. Laser beam 56 may have its axis of symmetry in reference plane 156 and may be focused to a spot smaller than the fiber diameter. A relative movement between the laser beam and the ferrule may be provided, such that the laser beam may sever the fiber length projecting out of ferrule end-face. Concurrently with fiber severing, the laser beam may remove excess epoxy (not shown). During the process of fiber severing, device 80 may be operative for collecting, disposing removed fiber debris, and device 82 may be operative for extracting fumes and odor generated by the epoxy and fiber removal process. Ferrule end-face cleaning system 84 may also be part of apparatus 150.

Ferrule end-face cleaning system 84 may clean end-face 36 and inspection system 92 may inspect ferrule 142 having removed excess epoxy 38 and fiber 32 projecting out of the ferrule end-face 36. Inspection of fiber 32 and end-face 36 may include fiber length determination, cleanliness of ferrule end-face, form and shape of fiber tip and other criteria. Computer 70 may control the operation of system 150 and may generate an inspection report containing the results of the inspection.

Batch processing of ferrules reduces the time required to prepare ferrules for polishing. It increases throughput of the polishing system and reduces optical cable manufacturing costs.

The method of removing excess epoxy and severing fiber length projecting out of the ferrule end-face results in fibers uniformly projecting out of the ferule end-face. The polishing of such ferrules uniformly progresses and leads to better surface quality.

While the exemplary embodiments of the present invention have been illustrated and described, it will be appreciated that various changes can be made therein without affecting the spirit and scope of the invention. The scope of the invention, therefore, is defined by reference to the following claims.

1.-42. (canceled)

43. A method of severing a fiber length projecting out of the end face of a plurality of ferrules, said method comprising:
a. mounting said plurality of ferrules in a polishing fixture;
b. determining for each of said plurality of ferrules fiber severing plane, said plane defining the length of the fiber to be left;
c. aiming a laser beam at said plane;
d. focusing said laser beam to a spot smaller than said fiber diameter, and
e. providing a relative movement between said laser beam and said ferrule such that said laser beam severs said fiber protruding out of said ferrule end-face.

44. The method of claim 43, wherein the excess epoxy present on said ferrule end-face is removed concurrently with said fiber severing.

45. The method of claim 43, wherein said ferrule end-faces having excess epoxy and fiber projecting out of said ferrule end-faces are inspected.

46. The method of claim 43, wherein said method further comprises:
a. collecting and disposing the removed fiber debris, and
b. extracting fumes and odor generated by the epoxy removal and fiber severing process.

47. The method of claim 43, wherein said method further comprises ferrule end-face cleaning.

48. The method of claim 43, wherein said ferrules mounted in said polishing fixture have their end-faces protruding at different lengths.

49. The method of claim 43, wherein said ferrules consist of fiber stubs, simplex fiber connectors, duplex fiber connectors and multi fiber connectors.

50. The method of claim 43, wherein said laser beam aiming comprises:
a. capturing the image of each of said plurality of ferrules;
b. determining said ferrule end-face boundary and the position of said fiber severing plane relative to said boundary, and
c. directing said laser beam such as to sever said fiber length in said fiber severing plane.

51. The method of claim 50, wherein said laser beam is directed such as to produce said fiber severing angle of 90 degrees.

52. The method of claim 43, wherein a scanning laser beam provides said relative movement between said laser beam and said ferrule.

53. The method of claim 43, wherein said polishing fixture movement provides said relative movement between said laser beam and said ferrule.

54. The method of claim 43, wherein the activation of said laser in course of said relative movement is synchronized with said ferrule location in said fixture.

55. An apparatus for severing a fiber length projecting out of the end face of a plurality of ferrules, said apparatus comprising:
a. a laser for emitting a laser beam;
b. an aiming and steering mechanism for positioning said laser beam;
c. optics for focusing said laser beam;
d. a mechanism for providing relative movement between said laser beam and said plurality of ferrules;
e. a polishing fixture for mounting said plurality of ferrules;
f. a camera with associated software for determining fiber severing plane for each of said plurality of ferrules, and
wherein said laser beam aiming and steering mechanism positions said laser beam at said severing plane, said optics focuses said laser beam to a spot smaller than said fiber diameter, and said mechanism provides a relative movement between said laser beam and said plurality of ferrules such that said laser beam severs said fiber projecting out of said ferrule end-face.

56. The apparatus of claim 55, wherein said laser beam removes excess epoxy present on said ferrule end-face concurrently with said fiber severing.

57. The apparatus of claim 55, wherein said apparatus further comprises an inspection system for inspecting said ferrules having removed excess epoxy and fiber projecting out of said ferrule end-face.

58. The apparatus of claim 55, wherein said severing plane determines the length of the remaining fiber.

59. The apparatus of claim 55, wherein said apparatus further comprises:
a. a device for collecting and disposing the removed fiber debris, and
b. a device for extracting fumes and odor generated by said epoxy and fiber removal process.

60. The apparatus of claim 55, wherein said apparatus further comprises a ferrule end-face cleaning device.

61. The apparatus of claim 55, wherein said polishing fixture comprises an assembly of at least two plates.

62. The apparatus of claim 55, wherein said polishing fixture comprises a solid body.

63. The apparatus of claim 55, wherein said laser beam steering mechanism automatically performs said laser beam aiming.

64. The apparatus of claim 55, wherein the laser scanning mechanism provides said relative movement between said laser beam and said ferrule.

65. The apparatus of claim 55, wherein said polishing fixture movement provides the relative movement between said laser beam and said ferrule.

66. The apparatus of claim 55, wherein said apparatus further comprises an optical cable support including at least one reel for receiving lengths of optical cables associated with the ferrule being processed.

67. The apparatus of claim 55, wherein said apparatus further comprises a flexible optical circuit support rack associated with said polishing fixture for supporting a flexible optical circuit associated with the ferrules being processed.

68. An apparatus for severing a fiber length projecting out of the ferrule end face, wherein said apparatus comprises:
a. a mount for mounting connector such that the distance between ferrule end face and a reference plane determines the length of the fiber left;
b. a laser beam having its axis of symmetry in said reference plane;
c. optics for focusing said laser beam in said reference plane to a spot smaller than said fiber diameter;
d. a movement system for providing a relative movement between said laser beam and said ferrule, such that said laser beam severs said fiber length projecting out of said ferrule end-face, and
e. an inspection system for inspecting said ferrules having removed excess fiber projecting out of said ferrule end-face.

69. The apparatus of claim 68, wherein said laser beam removes the excess epoxy present on said ferrule end-face concurrently with said fiber severing.

70. The apparatus of claim 68, wherein said apparatus further comprises:
a. a device for collecting and disposing the removed fiber debris, and
b. a device for extracting fumes and odor generated by the epoxy and fiber removal process.

71. The apparatus of claim 68, wherein said apparatus further comprises ferrule end-face cleaning device.

72. The apparatus of claim 68, wherein said mount further includes an exchangeable adaptor for mounting different types of connectors.

73. The apparatus of claim 68, wherein said apparatus further comprises an optical cable support including at least one reel for receiving lengths of optical cables associated with the ferrule being processed.

74. The apparatus of claim 68, wherein said apparatus further comprises a flexible optical circuit support rack associated with said polishing fixture for supporting a flexible optical circuit associated with the ferrules being processed.
